(19) United States
(12) Patent Application Publication
(10) Pub. No.: US 2006/0210032 A1
(43) Pub. Date: Sep. 21, 2006

(54) Multilevel dynamic call screening

(75) Inventors: Michel L.F. Grech, London (GB); Musa R. Unmehopa, Amersfoort (NL); Kumar V.V. Vemuri, Naperville, IL (US)

Correspondence Address: WILLIAMS, MORGAN & AMERSON, 10333 RICHMOND, SUITE 1100, HOUSTON, TX, 77042, US

(73) Assignee: Lucent Technologies, Inc

(21) Appl. No.: 11/083,058

(22) Filed: Mar. 17, 2005

(51) Int. Cl. H04M 1/64

(52) U.S. Cl. 379/88.19

(57) ABSTRACT

The present invention provides a method of communicating with at least a calling party and at least a called party. The method includes receiving information indicative of an incoming call from the calling party, accessing context information associated with the called party, and accessing a pass code provided by the calling party. The method also includes disposing of the incoming call based on the pass code and the context information.

### BACKGROUND OF THE INVENTION

1. Field of the Invention

This invention relates generally to communication systems, and, more particularly, to telecommunication systems.

2. Description of the Related Art

Several telecommunication vendors provide subscribers with a “call agent” or “call screening” service that is used to screen incoming calls. For example, a subscriber may create a profile including policies and/or rules for handling incoming calls. In operation, the call screening agent disposes of incoming calls to a called party according to pre-defined settings or rules in the profile. The call screening service typically allows the subscriber to customize the screening service to set policies or rules for call disposition based on an identity of the calling party, a time of day, and a static or dynamic disposition of the called party. For example, a Calling Line Identity (CLI) provided by the telecommunication system may indicate that the calling party is an important client, but a presence capability of the telecommunication system may indicate that the called party is in a meeting. The called party may, however, provide a policy or rule allowing calls from the important client to be received during the meeting.

Conventional call screening services rely on the Calling Line Identity (CLI), or a similar technique for identifying the calling party, to implement the policies or rules set by the subscriber. Calling Line Identity (CLI) delivery is not, however, ubiquitous in all networks around the world. For example, fixed line networks and international gateway exchanges typically do not provide a Calling Line Identity (CLI) capability or any other service that can provide the called party with information indicating the identity of the calling party. As a result, the call screening service may not always work in the intended or desired manner. For example, call screening agents may implement a blanket policy of refusing calls when the calling party cannot be identified. Calling parties who are roaming in a network including intermediate nodes that do not support CLI delivery may then have their calls blocked by call screening agents that implement the blanket policy of refusing unidentified calls. Other examples of calling parties that may have their calls blocked or refused include users calling from phone booths, from a Private Automatic Branch Exchange (PABX) that display a generic switchboard number instead of the extension number of the calling party, calling parties using a calling card service, and the like.

These limitations of the conventional call screening services may lead to user dissatisfaction and potentially to lost revenue for the service provider if frustrated subscribers switch to another service provider. For example, a business user may become frustrated if they are unable to receive important calls from clients while traveling because the call screening agent screens unidentified calls. For another example, personal subscribers may wish to accept calls from a loved one, irrespective of the policy and/or the phone number that the loved one is calling from.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for communicating with at least a calling party and at least a called party. The method includes receiving information indicative of an incoming call from the calling party, accessing context information associated with the called party, and accessing a pass code provided by the calling party. The method also includes disposing of the incoming call based on the pass code and the context information.

### BRIEF DESCRIPTION OF THE DRAWINGS

The invention may be understood by reference to the following description taken in conjunction with the accompanying drawings, in which like reference numerals identify like elements, and in which:

FIG. 1 shows a telecommunication network, in accordance with the present invention;

FIG. 2 conceptually illustrates one exemplary method for disposing of an incoming call based on context information and a pass code, in accordance with the present invention; and

FIG. 3 conceptually illustrates an exemplary scenario for disposing of an incoming call based on context information and a pass code, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

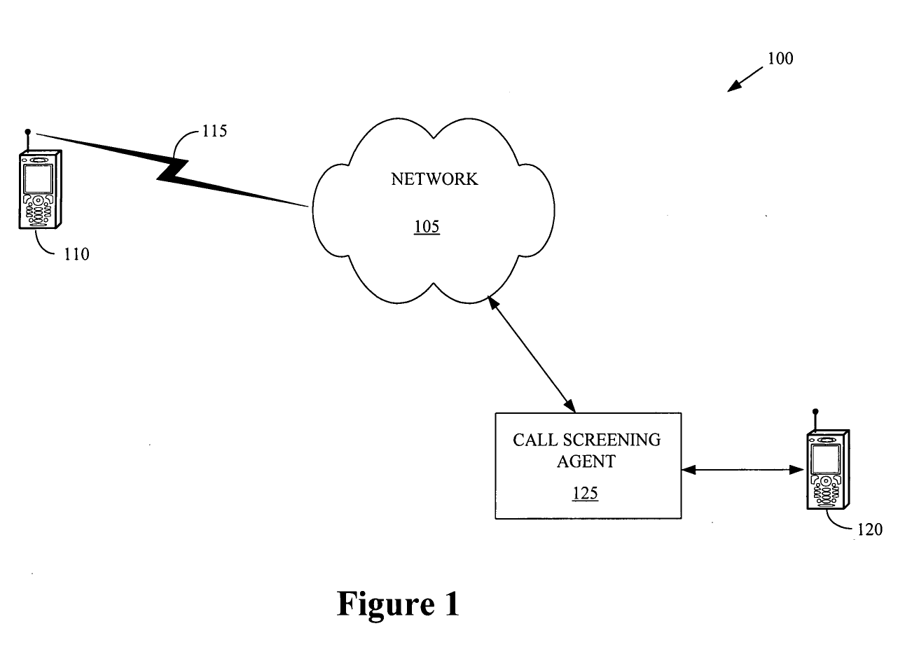

Referring now to FIG. 1, a telecommunications system 100 is shown. In the illustrated embodiment, the telecommunications system 100 includes a network 105. At least a portion of the network 105 shown in FIG. 1 is a wireless telecommunications network. In various alternative embodiments, the network 105 may operate according to one or more wireless telecommunications protocols. Exemplary wireless protocols include, but are not limited to, wide area radio telecommunications protocols such as Universal Mobile Telecommunication System (UMTS) protocols, Global System for Mobile telecommunications (GSM) protocols, Code Division Multiple Access (CDMA and/or CDMA 2000) protocols and local area telecommunications protocols such as Bluetooth protocols and one or more of the IEEE 802 protocols. However, persons of ordinary skill in the art having benefit of the present disclosure should appreciate that the present invention is not limited to any particular wired network, wireless network, or combination thereof. In alternative embodiments, the network 105 may include one or more wired networks. Exemplary wired networks include, but are not limited to, Internets, intranets, Plain Old Telephone Service (POTS) networks, Public Switched Telephone Networks (PSTN), and the like.

A mobile unit 110 is communicatively coupled to the network 105 over an air interface 115. The mobile unit 110 may also be referred to as the calling party 110 in the discussion that follows. Persons of ordinary skill in the art should appreciate that the term “calling party” may refer to either the mobile unit 110 or to a person using the mobile unit 110. As discussed above, the mobile unit 110 communicates with the network over the air interface 115 according to one or more wireless telecommunication protocols. However, persons of ordinary skill in the art having benefit of the present disclosure should appreciate that the calling party 110 does not have to be a mobile unit 110 or a user of a mobile unit 110. In alternative embodiments, the calling party 110 may be a wired telecommunication device (or a user thereof) connected to the network 105 by a wireline connection.

A mobile unit 120 is communicatively coupled to the network 105. The mobile unit 120 may also be referred to as the called party 120 in the discussion that follows. Persons of ordinary skill in the art should appreciate that the term “called party” may refer to either the mobile unit 120 or to a person using the mobile unit 120. As discussed above, the present invention is not limited to the mobile unit 120. In various alternative embodiments, the called party 120 may be a mobile unit or a wired telephone that may communicate with the network 105 according to any desirable wired and/or wireless telecommunication protocol.

The mobile unit 120 is also communicatively coupled to a call screening agent 125. Although the call screening agent 125 is depicted as a separate entity in FIG. 1, persons of ordinary skill in the art having benefit of the present disclosure should appreciate that the present invention is not limited to a standalone call screening agent 125. In alternative embodiments, portions of the call screening agent 125 may be deployed in any desirable location and/or device. For example, portions of the call screening agent 125 may be implemented in the network 105. For another example, portions of the call screening agent 125 may be implemented in the mobile unit 120. Furthermore, the call screening agent 125 may be implemented in any desirable combination of hardware and/or software.

The call screening agent 125 may receive information indicating that the calling party 110 is attempting to reach the called party 120. For example, the calling party 110 may provide a signal over the air interface 115 that is transmitted to the call screening agent 125 by the network 105. The call screening agent 125 is able to access context information associated with the called party 120, e.g. in response to the signal from the calling party 110. As used herein, the term “context information” refers to information associated with the current context of the called party 120 (a device and/or a user of the device). Context information may include information associated with the physical context of the called party 120, the temporal context of the called party 120, availability of the called party 120, the current state of mind of the called party 120, and the like. For example, the call screening agent 125 may access information indicating whether or not the called party 120 is present, temporal information such as a time of day and/or a time zone associated with the called party 120, spatial information such as a current location of the called party 120, and/or whether or not the called party 120 is available to (or wants to) receive the incoming call.

The call screening agent 125 is also able to access a pass code provided by the calling party 110. As used herein, the term “pass code” refers to information provided by the calling party 110 in addition to the information required by the telecommunications system 100 to establish a call between the calling party 110 and the called party 120. In one embodiment, the pass code indicates the identity of the calling party 110 or a priority associated with the calling party 110. For example, the calling party 110 may provide a phone number associated with the called party 120 so that the telecommunications system 100 may establish a call between the calling party 110 in the called party 120. The calling party 110 may also provide a pass code indicative of the identity of the calling party 110, such as a four-digit Personal Identification Number. In one embodiment, the pass code may be provided as a dual-tone multifrequency (DTMF) signal, such as a Touch Tone® signal. However, the present invention is not limited to pass codes that are provided as DTMF signals. For example, the calling party 110 may say the pass code into a microphone and a voice-recognition system may convert the spoken pass code into a signal that may be understood by the call screening agent 125. The call screening agent 125 can dispose of the incoming call based on the pass code and the context information.

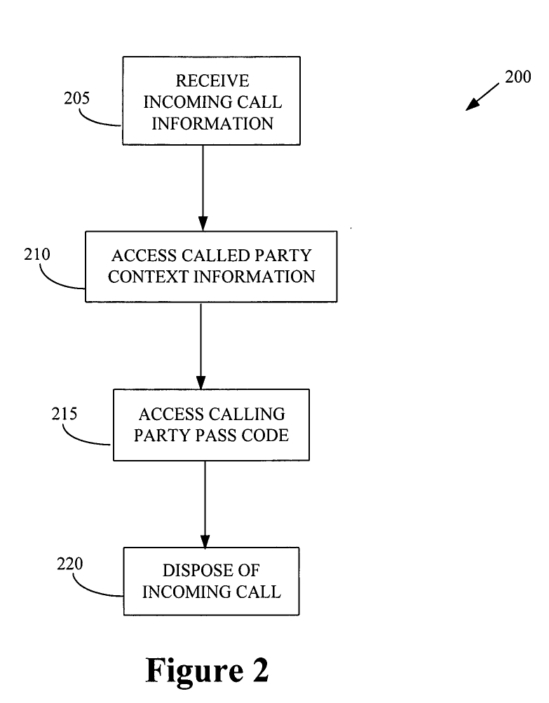

FIG. 2 conceptually illustrates one exemplary method 200 of handling incoming call based on a pass code associated with a calling party and context information associated with a called party. In the illustrated embodiment, information indicative of an incoming call is received (at 205). For example, a calling party may provide a signal indicating that the calling party would like to establish a call with the called party. In one embodiment, the received (at 205) information may include a Calling Line Identifier (CLI) that indicates the identity and/or phone number of the calling party. However, persons of ordinary skill in the art should appreciate that in some embodiments the information indicating the identity and/or phone number of the calling party, such as the Calling Line Identifier (CLI), may not be available. Context information associated with the called party is accessed (at 210) in response to receiving (at 205) the indication of the incoming call. As discussed above, context information may include presence information, temporal information, spatial information, availability information, and the like.

One or more pass codes provided by the calling party is accessed (at 215). In one embodiment, the accessed (at 215) pass code may be used to identify the calling party. Alternatively, the accessed (at 215) pass code may be used to determine a priority of the incoming call being placed by the calling party. For example, the pass code may be Personal Identification Number that is. provided by the calling party as a DTMF signal, which may be decoded and used to verify the identity of the calling party. In one embodiment, the pass code is used to identify the calling party when Calling Line Identifiers are not available. However, the present invention is not limited to accessing (at 215) the pass code when Calling Line Identifiers are not available. In alternative embodiments, the pass code may be accessed (at 215) when Calling Line Identifiers are available. The calling party may or may not be prompted to provide the pass code, depending on the context.

The incoming call is disposed (at 220) based on the pass code and the context information. In various alternative embodiments, disposing (at 220) of the incoming call may include disconnecting the incoming call, redirecting the incoming call to a voicemail system, or connecting the calling party to the called party. In one embodiment, the incoming call may be disposed (at 220) in response to expiration of a timer. For example, even though no Calling Line Identifiers are provided, the calling party may provide a pass code indicating that the calling party is a person known to the called party and the context information may indicate that the called party is available, in which case the calling party may be connected to the called party. For another example, a Calling Line Identifier may indicate that the calling party is the spouse of the called party. However, the context information may indicate that the called party is in a meeting and does not wish to be disturbed except in emergencies. The calling party may provide a pass code indicating that the incoming call has a very high priority, in which case the incoming call may be connected to the called party.

Different levels of interrupt, from “override at any cost” to low priority (e.g. divert automatically to voice mail) may be provided by disposing (at 220) of the incoming calls based on context information and pass codes. For example, a call screening agent may collect pass codes that are provided to a call screening agent that can collect pre-defined codes (such as in the form of DTMF tones) from the calling user when the CLI is not provided or not recognized by the call screening service of the subscriber (i.e. the called user). For another example, the call screening agent may collect pass codes for an identifiable caller to allow various levels of interrupt. The pass code format may be determined by the subscriber to the services, and could be used to identify particular persons, or group of persons, emergencies, and the like.

In one embodiment, the subscriber to the service may offer multiple codes to different potential calling parties, and each code could have a different policy, such as a variable level of priority. For example, when the calling party (or network) does not provide a Calling Line Identifier, in which case the default policy is to divert the incoming call to the called party's voice mail at the time of the incoming call, the call screening agent could use the multiple priority levels to determine whether to override the default policy and provide the call to the called party. The decision to provide the incoming call may be made based on the called party's “status,” which can be determined based on context information such as presence information, the called party's personal policies, on-line calendar information, and the like. The called party's status may indicate that the called party is too busy to receive incoming calls associated with some pass codes, but not too busy not to accept incoming calls associated with other pass codes.

The pass codes may also be used to indicate additional levels of urgency. Under some circumstances urgent pass codes could allow an incoming call to be completed to the called party in a special emergency, whereas non-urgent pass codes may result in the incoming call being diverted to voice mail. For example, when a wife in labor calls her husband and provides an urgent pass code, the incoming call may be connected even though the husband is in a business meeting. On the other hand, if the wife calling the husband to remind him to buy dog food on the way home, she may provide a non-urgent pass code and the incoming call may be diverted to voice mail if the husband is busy. In one embodiment, the called party could provide a person (or group of persons) with several pass codes, each representing an escalating level of urgency, or even a pass code that automatically sends the call to voice mail irrespective of the called party's status.

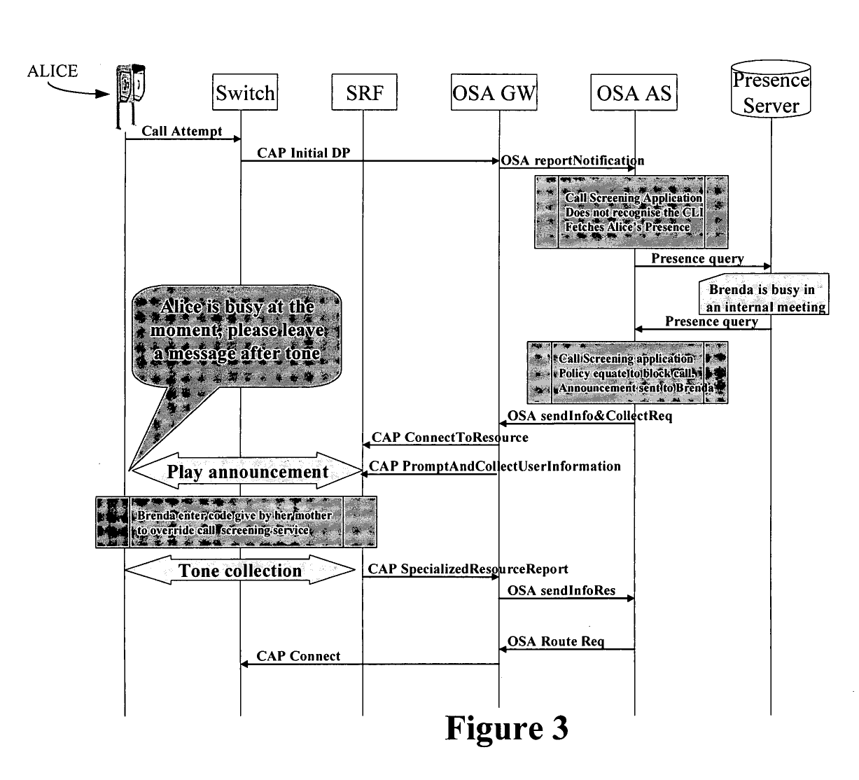

FIG. 3 conceptually illustrates an exemplary scenario for disposing of an incoming call based on context information and a pass code. Persons of ordinary skill in the art should appreciate that the exemplary scenario shown in FIG. 3 is intended to illustrate operation of the present invention in a particular context, but is not intended to limit the present invention. In the illustrated embodiment, a user named Alice (indicated by the mobile phone shown in FIG. 3) may want to allow her teenager daughter Brenda to reach her at any time from any phone, even if her presence indicates that she is in a say internal meeting. Alice issues Brenda a pass code (e.g. in the form of a 4 digit code to be used in an emergency to contact her).

In the present scenario, Brenda has missed her last bus ride from school and while she has a mobile phone, it is unusable (her battery has run out, or her pre-paid credit is insufficient . . . etc). Brenda wishes to call her mother Alice, a busy businesswoman who uses an automated call screening service. Brenda uses a payphone to call her mother but the phone booth does not provide a CLI, or the call screening service does not recognize the payphone number as a number that is in Alice's policy list. The call screening service reads Brenda's presence service and determines that Brenda is “busy in a meeting” and based on all this information starts an announcement to Brenda stating that “Alice is busy and unable to take the call.”

During this announcement phase, Brenda enters the pass code that was provided by her mother that identifies Brenda. The call screening service recognizes that this pass code is the 4 digit code indicating that this is an emergency call from Brenda and forwards the call to Alice. In some embodiments, the 4 digit code may also be used to determine the Brenda is calling, in which case a message, such as “Emergency call from Brenda” may be displayed to Alice when the call is connected. In this scenario, the call screening service does not advertise the fact that a pass code can be collected to respect Alice's privacy settings that indicated that she did not want callers to know that this is activated. Thus, only the authorized code holders may even be aware of the possibility of entering a pass code. However, in alternative scenarios, the call screening service may advertise (e.g. by providing a prompt) the fact that pass codes may be collected.

If the network operates according to OSA/Parlay protocols, the scenario described above may operate as follows (and as illustrated in FIG. 3). In this scenario, Intelligent Network triggers are armed in the network. Techniques for arming the Intelligent Network triggers are known to persons of ordinary skill in the art and, in the interest of clarity, will not be discussed further herein. When Brenda calls Alice, the Call Attempt event will be detected in the network and an armed trigger will result in a CAP Initial DP sent to the OSA Gateway (OSA GW). At the OSA Gateway, the receipt of the CAP Initial DP will result in the method invocation reportNotification towards the OSA Application Server(OSA AS). In this scenario, the call screening service is running at the OSA Application Server (OSA AS).

The OSA AS may perform a Presence query to obtain context-sensitive information to determine Alice's disposition. The call screening service does not recognize the phone booth number and thus the outcome of the policy decision “Alice is Busy and number not recognized” is to block the call (i.e. send to Alice's voice mail). The announcement is required to inform Brenda and the application at the OSA AS, the OSA AS will request an announcement to be played, using the sendInfoReq OSA method invocation. However instead of leaving a message, Brenda enters the code that was previously provided by her mother. The call screening service recognizes this code (via a CAP SpecilaizeResourceReport) as identifying Brenda and applies a new policy so that the call is routed to Alice via an OSA Route Call message, resulting in a CAP Connect message. Although this exemplary scenario is described in the context of OSA technologies, persons of ordinary skill in the art should appreciate that alternate technologies (e.g. traditional IN, CAMEL, IMS, web services, and the like) may also be used.

In various alternative embodiments, technologies including VoiceXML, Text To Speech Engines, and the like could be used to realize the custom announcements needed to support the kinds of scenarios outlined above, in different network contexts (IMS, CAMEL etc).Moreover, different technologies may be used to realize how the code is sent to the call screening service, in our example, DTMF is used but our invention subsumes all others. In one embodiment, the call screening service allows a subscriber to set policies that may be used to treat incoming calls automatically.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of communicating with at least a calling party and at least a called party, comprising:
receiving information indicative of an incoming call from the calling party;
accessing context information associated with the called party;
accessing a pass code provided by the calling party; and
disposing of the incoming call based on the pass code and the context information.

2. The method of claim 1, wherein accessing the context information comprises accessing at least one of presence information, temporal information, spatial information, and availability.

3. The method of claim 1, wherein accessing the pass code comprises accessing a pass code indicative of at least one of an identity of the calling party and a priority of the incoming call.

4. The method of claim 1, wherein accessing the pass code comprises:
providing a notification indicative of a request for the pass code; and
receiving information indicative of the pass code in response to providing the notification.

5. The method of claim 4, wherein receiving the information indicative of the pass code comprises:
receiving a dual tone multifrequency signal indicative of the pass code; and
decoding the dual tone multifrequency signal to determine the pass code.

6. The method of claim 1, wherein disposing of the incoming call comprises at least one of disconnecting the incoming call, directing the incoming call to a voice mail box, and connecting in the incoming call to the called party.

7. The method of claim 6, wherein disposing of the incoming call comprises disposing of the incoming call in response to expiration of a timer.

8. The method of claim 1, comprising receiving information indicative of the calling party.

9. The method of claim 8, wherein disposing of the incoming call comprises disposing of the incoming call based on the pass code, the context information, and the information indicative of the calling party.

10. The method of claim 8, wherein receiving information indicative of the calling party comprises receiving a Calling Line Identifier.

11. The method of claim 1, comprising:
accessing context information associated with the calling party; and
disposing of the incoming call based on the pass code and the context information associated with the called party and the calling party.
